(19) United States
(12) Patent Application Publication
(10) Pub. No.: US 2017/0300837 A1
(43) Pub. Date: Oct. 19, 2017

(54) BUSINESS OPERATION EVALUATION SYSTEM

(71) Applicant: DENSO CORPORATION, Kariya-city (JP)

(72) Inventors: Atsushi Moribe, Kariya-city (JP); Minoru Fujioka, Kariya-city (JP)

(21) Appl. No.: 15/489,459

(22) Filed: Apr. 17, 2017

(30) Foreign Application Priority Data
Apr. 19, 2016 (JP) 2016-083698

(51) Int. Cl. G06Q 10/06; G06F 17/30

(52) U.S. Cl. CPC G06Q 10/063; G06F 17/30283

(57) ABSTRACT

In a business operation evaluation system, a business operation data collecting unit collects business operation data related to a business operation. A first database stores therein analysis data used to analyze the collected business operation data. A second database stores therein names of business operation phases indicating stages of the business operation and names of processes included in the business operation phases. The names of business operation phases and the names of processes are associated with each other. An analyzing unit analyzes the collected business operation data using the analysis data stored in the first database. A third database stores therein analysis result data as evaluation target data. A fourth database stores therein the analysis result data as past data. An evaluating unit evaluates the evaluation target data by comparing the evaluation target data with the past data stored in the fourth database.

### CROSS-REFERENCE TO RELATED APPLICATION

This application is based on and claims the benefit of priority from Japanese Patent Application No. 2016-083698, filed Apr. 19, 2016. The entire disclosure of the above application is incorporated herein by reference.

### BACKGROUND

### Technical Field

The present disclosure relates to a business operation evaluation system.

### Related Art

In a business operation such as product development, business operation content related to development is required to be evaluated and improved, from the perspective of preventing occurrences of post-development defects and the like. For example, JP-A-2009-187330 discloses a technology in which relevant staff (i.e., a person in charge of each business operation) answer a questionnaire created by an administrator, and the business operation content is evaluated based on statistical results of the answers.

However, in the conventional technology, because the administrator who creates the questionnaire is a human, and the subjective view of the administrator may be reflected in the content of the questionnaire. In addition, the relevant staff member who answers the questionnaire is also a human and thus, the subjective view of the relevant staff may be reflected in the content of the answers. Consequently, in the conventional technology, eliminating the subjective views of people and objectively evaluating the business operation content becomes difficult. In addition, in the conventional technology, creating the questionnaire is troublesome for the administrator and answering the questionnaire is troublesome for the relevant staff. Therefore, the motivation to evaluate and improve the business operation content may be lost.

### SUMMARY

It is thus desired to provide a business operation evaluation system that enables business operation content to be objectively evaluated without requiring time and effort by an administrator and relevant staff, and while eliminating subjective views of people.

An exemplary embodiment of the present disclosure provides a business operation evaluation system that includes a business operation data collecting unit, a first database, a second database, an analyzing unit, a third database, a fourth database, and an evaluating unit. The business operation data collecting unit collects business operation data related to business operation. The first database stores therein analysis data used to analyze the business operation data collected by the business operation data collecting unit. The second database stores therein names of business operation phases indicating stages of the business operation and names of processes included in the business operation phases. The names of business operation phases and the names of processes are associated with each other. The analyzing unit analyzes the business operation data collected by the business operation data collecting unit using the analysis data stored in the first database. The third database stores therein, as evaluation target data, analysis result data acquired through the analysis performed by the analyzing unit. The fourth database stores therein, as past data, the analysis result data stored in the third database as the evaluation target data. The evaluating unit evaluates the evaluation target data stored in the third database by comparing the evaluation target data with the past data stored in the fourth database.

The business operation evaluation system of the present disclosure automatically generates current evaluation target data from the collected business operation data. Then, the current evaluation target data that has been generated is evaluated based on a comparison with the past data that has been evaluated in a past business operation evaluation process. As a result of this configuration, business operation content can be objectively evaluated without requiring time and effort by an administrator and relevant staff, and while eliminating subjective views of people.

### BRIEF DESCRIPTION OF THE DRAWINGS

In the accompanying drawings:

FIG. 1 is a diagram schematically showing a configuration example of a business operation evaluation system according to a present embodiment;

FIG. 2 is a diagram (1) of an example of business operation data;

FIG. 3 is a diagram (2) of an example of business operation data;

FIG. 4 is a diagram (3) of an example of business operation data;

FIG. 5 is a diagram (4) of an example of business operation data;

FIG. 6 is a diagram (5) of an example of business operation data;

FIG. 7 is a diagram (6) of an example of business operation data;

FIG. 8 is a diagram (7) of an example of business operation data;

FIG. 9 is a diagram (8) of an example of business operation data;

FIG. 10 is a diagram (9) of an example of business operation data;

FIG. 11 is a diagram schematically showing a configuration example of a first database;

FIG. 12 is a diagram schematically showing a configuration example of a second database;

FIG. 13 is a diagram schematically showing a configuration example of a third database;

FIG. 14 is a diagram schematically showing a configuration example of a fourth database;

FIGS. 15A and 15B are diagrams of examples of time-series data;

FIG. 16 is a diagram of an example of network data;

FIG. 17 is a diagram of an example of transmission and reception of email;

FIG. 18 is a diagram of an example of comparison of time-series data;

FIG. 19 is a diagram of an example of comparison of network data;

FIG. 20 is a diagram of an example in which probability distributions of the number of times of email transmission-reception is generated;

FIG. 21 is a flowchart of an example of a business operation evaluation process;

FIG. 22 is a diagram of an example of an arithmetic expression used in an evaluation point calculation process;

FIG. 23 is a flowchart (1) of an example of the evaluation point calculation process;

FIG. 24 is a flowchart (2) of the example of the evaluation point calculation process;

FIG. 25 is a diagram of an example of identification of an improvement-required period; and

FIG. 26 is a diagram of a case in which a business operation period is divided into a plurality of periods and evaluated.

### DESCRIPTION OF THE EMBODIMENTS

An embodiment of a business operation evaluation system will hereinafter be described with reference to the drawings.

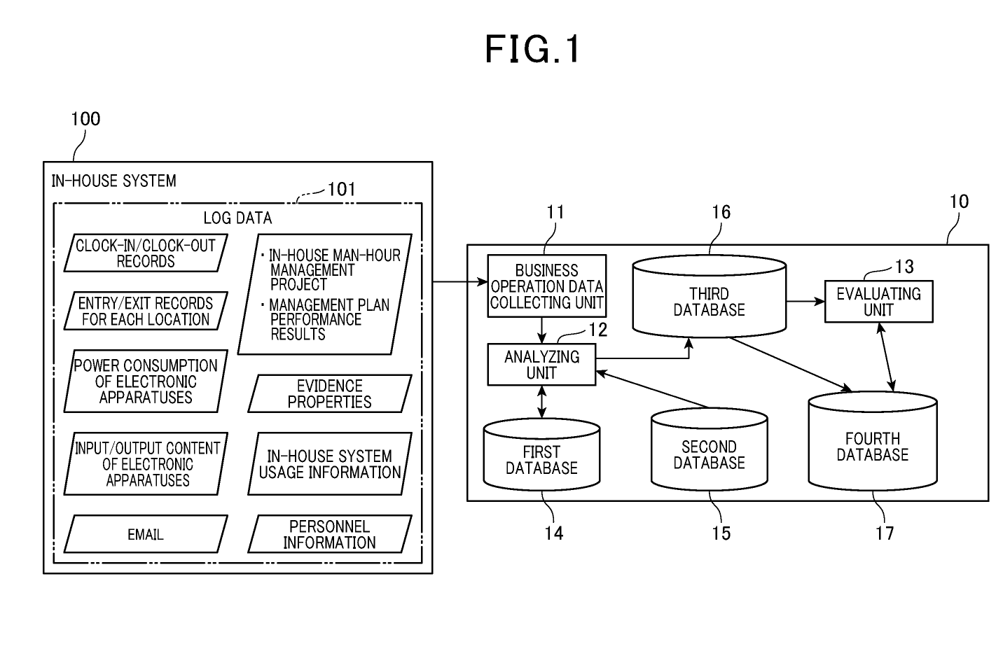

A business operation evaluation system 10 shown in the example in FIG. 1 includes a business operation data collecting unit 11, an analyzing unit 12, an evaluating unit 13, a first database 14, a second database 15, a third database 16, a fourth database 17, and the like. The business operation data collecting unit 11, the analyzing unit 12, and the evaluating unit 13 are implemented by software by, for example, a program being run by an information processing terminal, such as a personal computer. The business operation data collecting unit 11, the analyzing unit 12, and the evaluating unit 13 may also be actualized by hardware or by a combination of software and hardware.

The business operation data collecting unit 11 collects business operation data related to business operations from an in-house system 100. The in-house system 100 is constructed within a company. Information related to various types of business operations are present in the in-house system 100 as log data 101, which is an example of the business operation data.

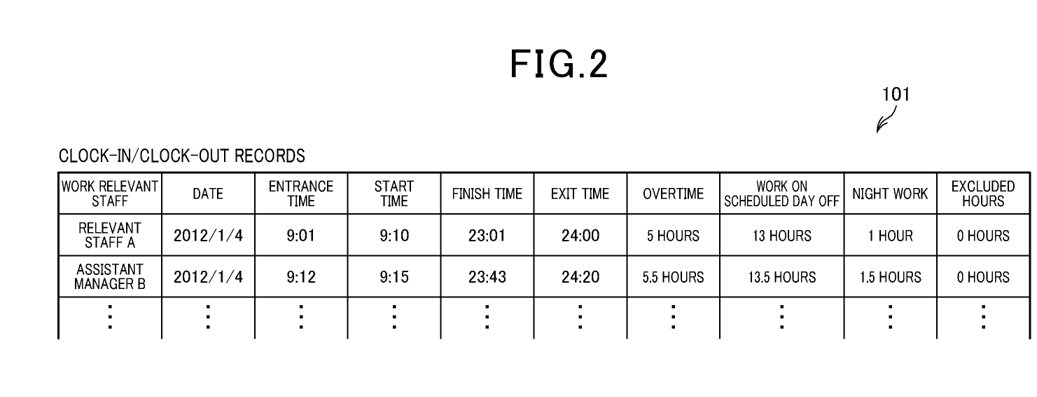

For example, as shown in FIGS. 2 to 10, the log data 101 includes information such as clock-in/clock-out records, entry/exit records for each location, power consumption of electronic apparatuses, input-output content of electronic apparatuses, electronic mail (email), in-house man-hour management and project management plan performance results, evidence properties, data 109 of in-house system usage information, and personnel information.

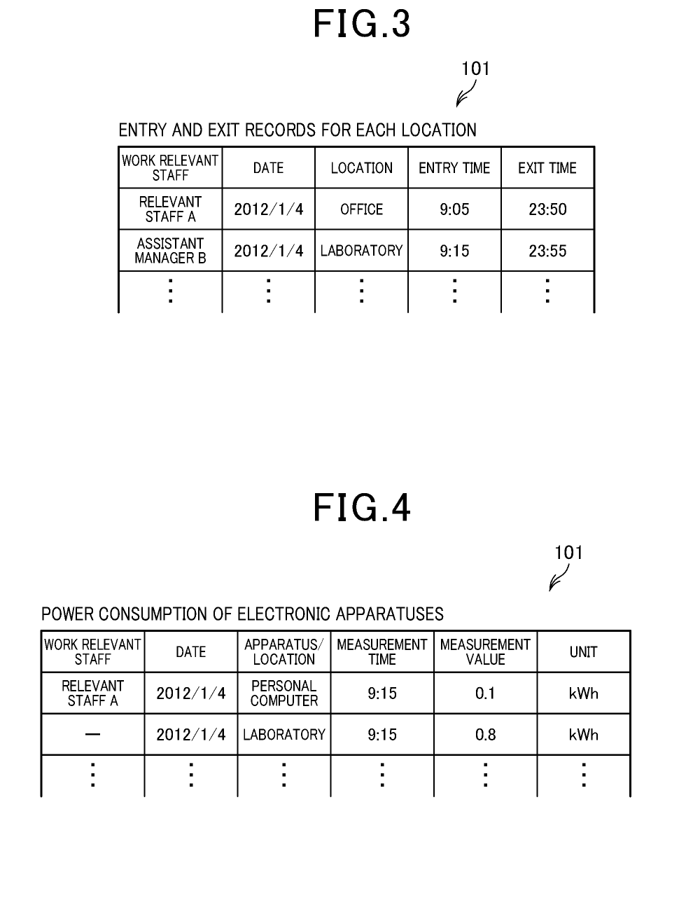

As shown in FIG. 2, the log data 101 includes information of clock-in/clock-out records such as work relevant staff, date, entrance time, start time, finish time, exit time, overtime, work on scheduled day off, night work, and excluded hours. As shown in FIG. 3, the log data 101 includes information of entry/exit records for each location such as work relevant staff, date, location, entry time, and exit time. As shown in FIG. 4, the log data 101 includes information of the power consumption of electronic apparatuses such as work relevant staff, date, apparatus/location, measurement time, measurement value, and unit.

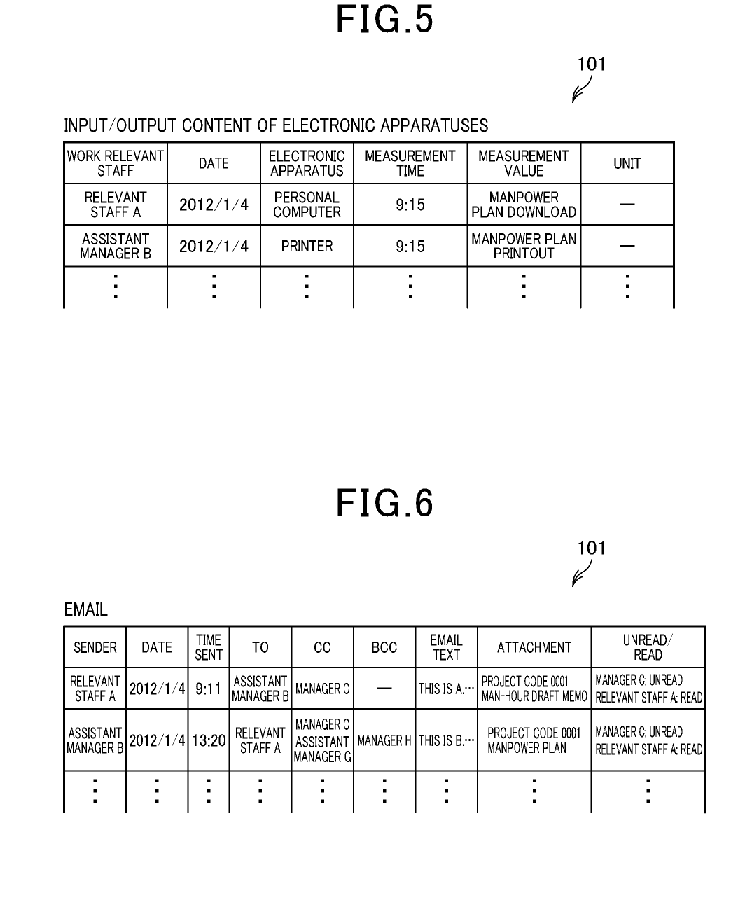

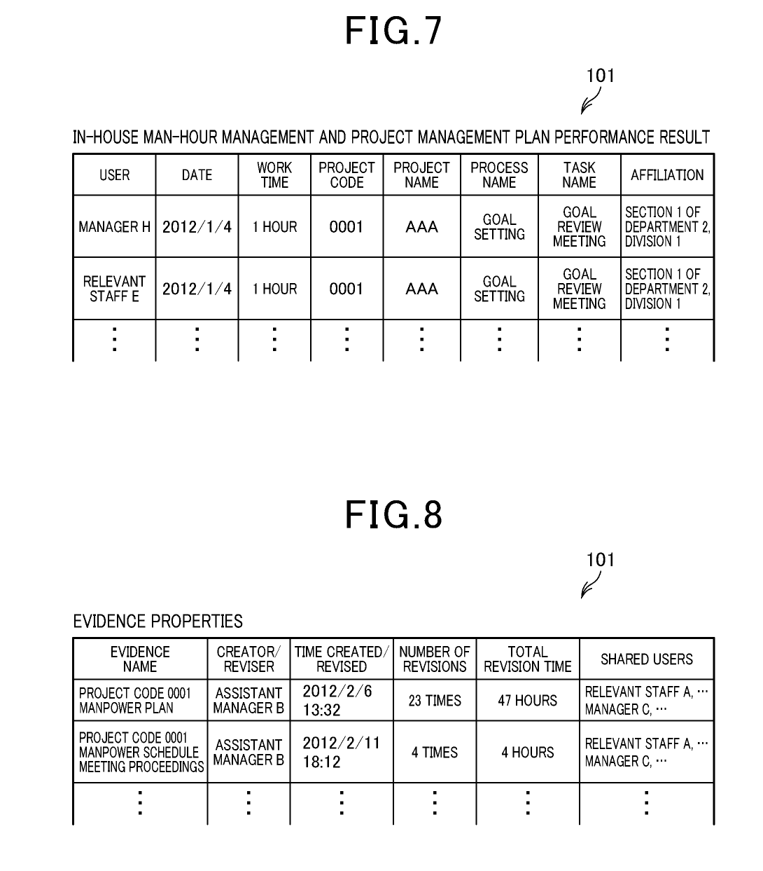

As shown in FIG. 5, the log data 101 includes information of input-output content of electronic apparatuses such as work relevant staff, date, electronic apparatus, measurement time, measurement value, and unit. As shown in FIG. 6, the log data 101 includes information of email such as sender, date, time sent, destination (to), carbon copy (cc),blind carbon copy (bcc), email text, attachment, and unread/read. As shown in FIG. 7, the log data 101 includes information of in-house man-hour management and project management plan performance results such as user, date, work time, project code, project name, process name, task name, and affiliation.

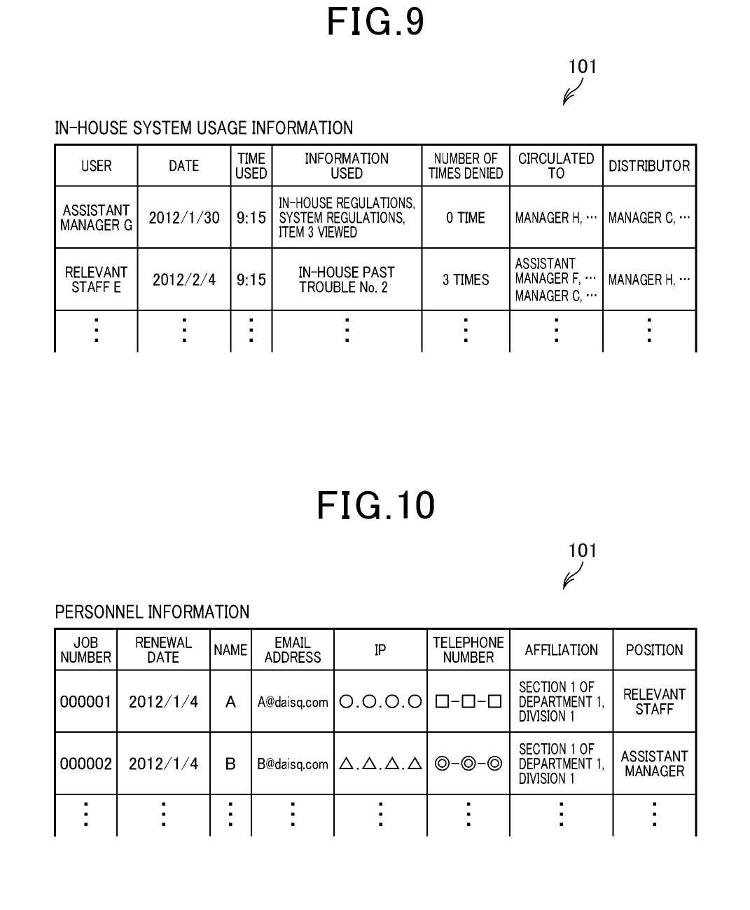

As shown in FIG. 8, the log data 101 includes information of evidence properties such as evidence name, creator/reviser, time created/revised, number of revisions, total revision time, and shared users. As shown in FIG. 9, the log data 101 includes in-house system usage information such as user, date, time used, information used, number of times denied, circulated to, and distributor. As shown in FIG. 10, the log data 101 includes personnel information such as personnel information, job number, renewal date, name, email address, IP, telephone number, affiliation, and position.

For example, the collection of business operation data by the business operation data collecting unit 11 can be performed through use of common data collection tools.

The analyzing unit 12 analyzes the business operation data collected by the business operation data collecting unit 11 using analysis data stored in the first database 14. In this case, the analyzing unit 12 analyzes the business operation data by so-called corpus analysis in which language and the like included in the data is structurally analyzed. For example, the analysis by the analyzing unit 12 can be performed through use of common analysis software or analysis algorithms. The analyzing method used by the analyzing unit 12 is not limited to corpus analysis.

The evaluating unit 13 evaluates evaluation target data, which is the data to be evaluated, by comparing the data to past data. The evaluation target data is stored in the third database 16. The past data is stored in the fourth database 17.

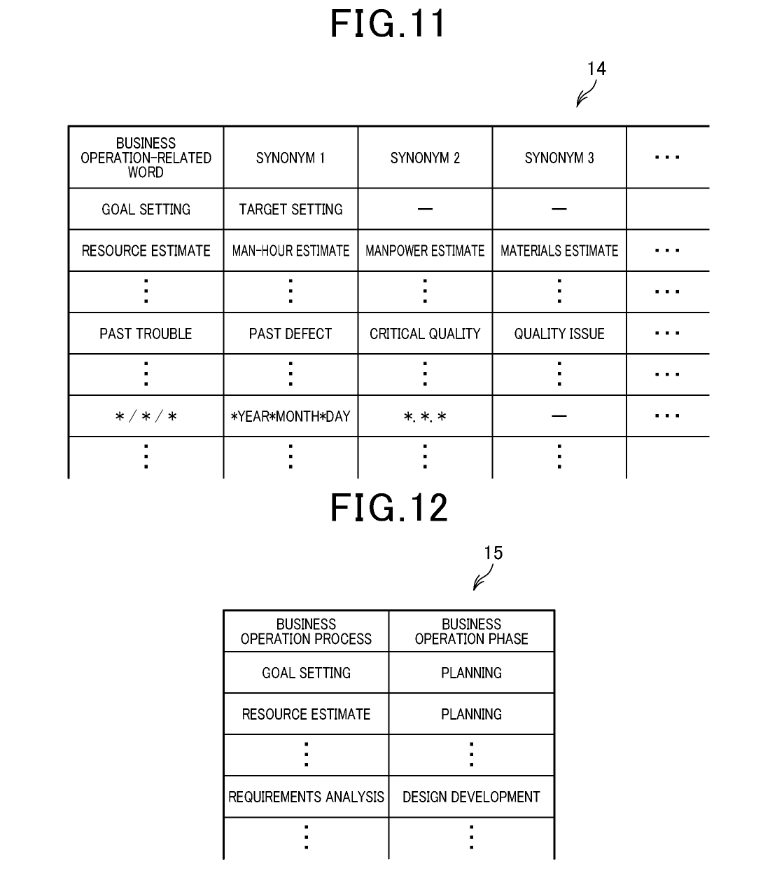

The first database 14 stores therein the analysis data used to analyze the business operation data collected by the business operation data collecting unit 11. That is, as shown in an example in FIG. 11, business operation process names and synonyms of the business operation process names are associated and stored in the first database 14. In addition, business operation-related terms, such as past trouble, and synonyms of the business operation-related terms are associated and stored in the first database 14. Furthermore, notation formats for date and time and similar notation formats are associated and stored in the first database 14.

When the business operation data collected by the business operation data collecting unit 11 includes a business operation process name or a synonym thereof stored in the first database 14, the analyzing unit 12 acknowledges that the business operation data is data on a business operation related to the business operation process. The analyzing unit 12 then groups a plurality of pieces of business operation data that are acknowledged as being related to the same business operation process, or in other words, performs name-based aggregation.

In addition, when a business operation-related term or a synonym thereof to be stored in the first database 14 is included in analysis result data that is evaluated as being success-case data in a past business operation evaluation process, the first database 14 classifies the term or the synonym as a success-case word. In addition, when a business operation-related term or a synonym thereof to be stored in the first database 14 is included in analysis result data that is evaluated as being failure-case data in a past business operation evaluation process, the first database 14 classifies the term or the synonym as a failure-case word.

For example, when failure-case words appear with predetermined frequency in an email text to be analyzed, such as five or more words per 400 characters, the analyzing unit 12 can add failure-suspected information to the analysis result data. The failure-suspected information indicates that the current business operation to be analyzed has a high likelihood of becoming a failure case. In addition, for example, when success-case words appear with predetermined frequency in an email text to be analyzed, such as five or more words per 400 characters, the analyzing unit 12 can add success-anticipated information to the analysis result data. The success-anticipated information indicates that the current business operation to be analyzed has a high likelihood of becoming a success case (being successful).

The second database 15 associates and stores therein the names of business operation phases, each indicating a stage in a business operation, and the names of processes included in the business operation phases. That is, as shown in an example in FIG. 12, for example, regarding a business operation phase indicating a business operation stage that is planning, business operation processes such as goal setting and resource estimate, which are processes included in the planning phase, are associated and stored in the second database 15. The analyzing unit 12 can identify the business operation phase to which the business operation data collected by the business operation data collecting unit 11 is related based on the information stored in the second database 15.

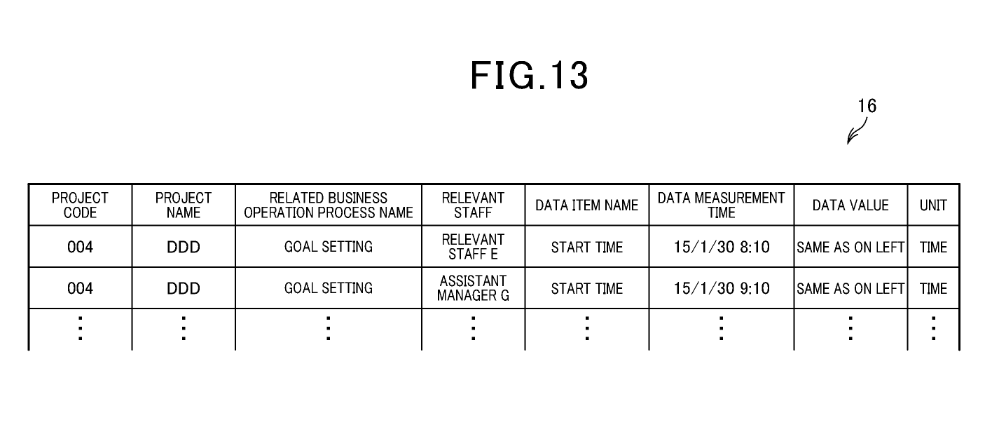

The third database 16 stores therein the analysis result data acquired through the analysis process performed by the analyzing unit 12 as the evaluation target data. That is, as shown in an example in FIG. 13, the analysis result data that is to be evaluated in the current business operation evaluation process is stored in the third database 16.

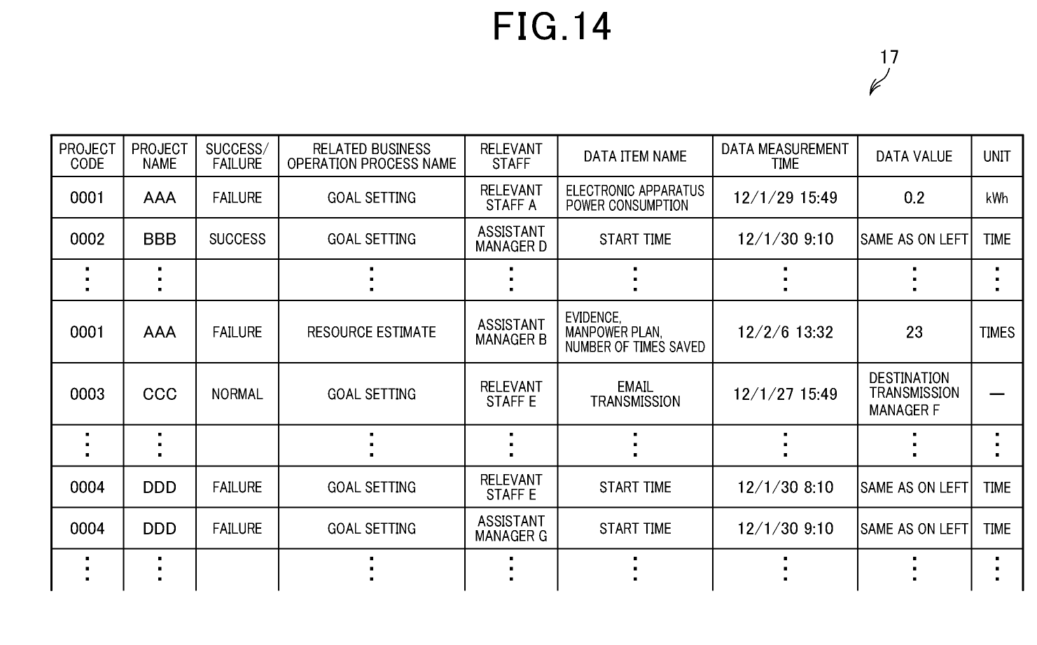

The fourth database 17 stores therein, as the past data, the analysis result data stored as the evaluation target data in the third database 16. That is, as shown in an example in FIG. 14, the pieces of analysis result data that have been evaluated in past business operation evaluation processes are successively stored in the fourth database 17 as the past data. In addition, the fourth database 17 classifies the past data into the success-case data, the failure-case data, and normal-case data.

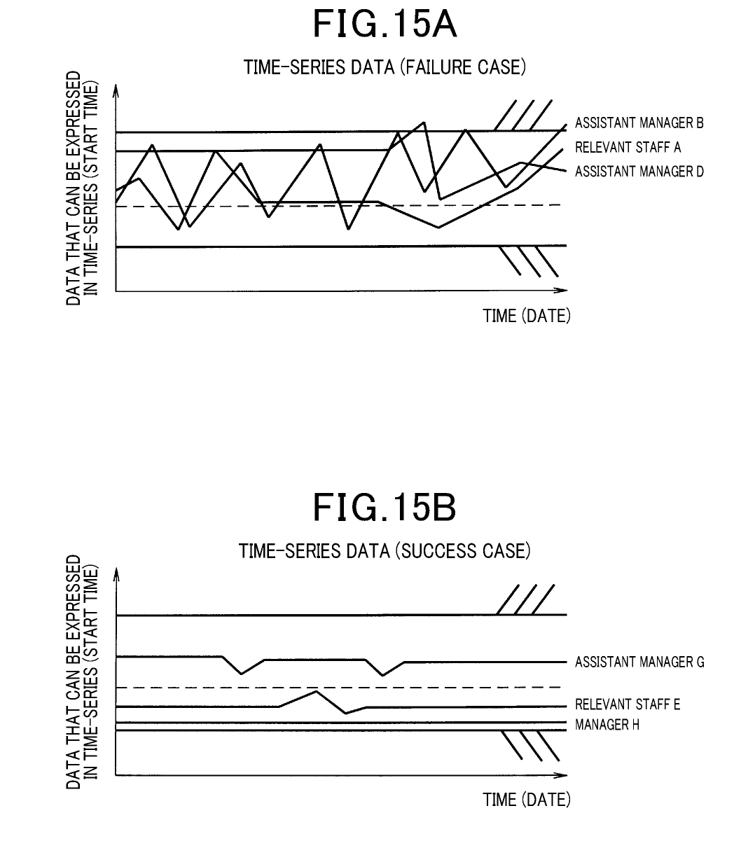

The analysis result data from the analyzing unit 12 can mainly be classified into time-series data and network data. That is, as shown in examples in FIGS. 15A and 15B, the time-series data is data ascertainable from the various types of business operation data acquired from the in-house system 100 that can be expressed in time-series. The time-series data shown in the example in FIG. 15A indicates the start time of each relevant staff (person in charge of each business operation) of business operations that have been evaluated as being a failure case. In addition, the time-series data shown in the example in FIG. 15B indicates the start time of each relevant staff of business operations that have been evaluated as being a success case.

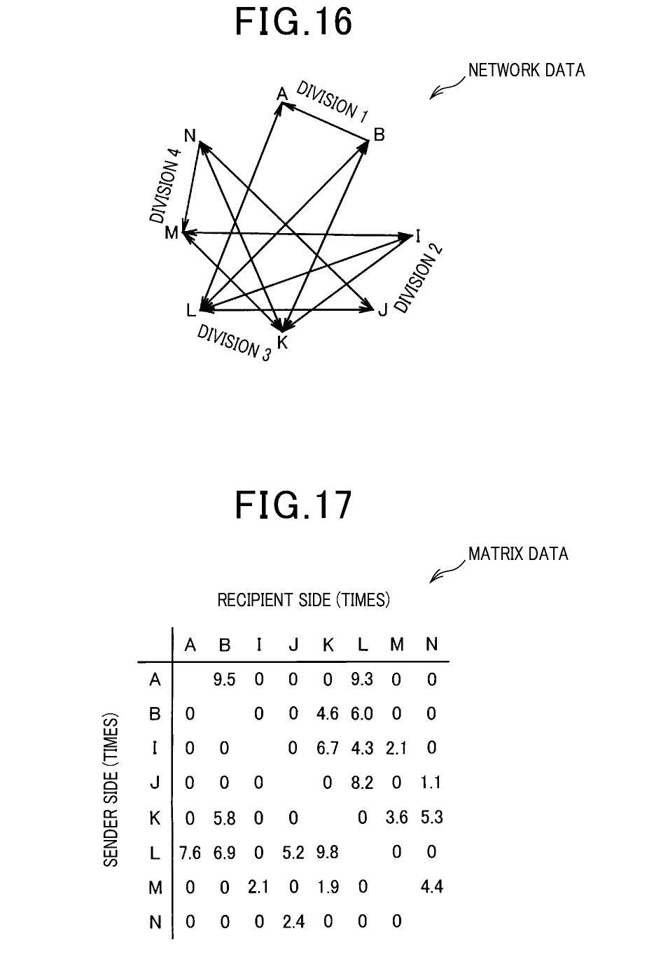

Furthermore, as shown in an example in FIG. 16, the network data is data ascertainable from the various types of business operation data acquired from the in-house system 100 that can be expressed by a network between elements configuring a business operation. The network data shown in the example in FIG. 16 expresses the transmission and reception of email among a plurality of divisions in the form of a network. The divisions are an example of elements configuring a business operation. In addition, alphabets A to N shown in the example in FIG. 16 indicate relevant staffs belonging to the divisions. For example, relevant staffs A and B belong to division 1.

FIG. 17 shows an example of the number of times of email transmission-reception among the relevant staffs A to N. The numeric values shown in FIG. 17 indicates the number of times of email transmission-reception that is obtained by adding the following values: (i) a value of 1 time that is used when a relevant staff is entered in a destination filed of a transmitted or received email; (ii) a value of 0.5 times that is used when a relevant staff is entered in a carbon copy (CC) field of a transmitted or received email; and (iii) a value of 0.1 times that is used when a relevant staff is entered in a blind carbon copy (BCC) field of a transmitted or received email.

Various types of data can be considered as the network data. For example, the network data may be: (i) data associating the entry/exit records for each location with each relevant staff; (ii) data associating electronic apparatuses that have been used with the relevant staff who has used the electronic apparatuses; (iii) data associating various types of evidence created in a business operation with the shared users of the evidence; data associating various types of business operation data that have been used with the relevant staff who has used the business operation data; (iv) data associating meetings that have been held with the attendees of the meetings; and (v) data associating each division with information used in the division. That is, in cases in which directivity can be found in the business operation content, in cases in which complicated exchange is performed among a plurality of elements, and the like, the data is preferably expressed as network data.

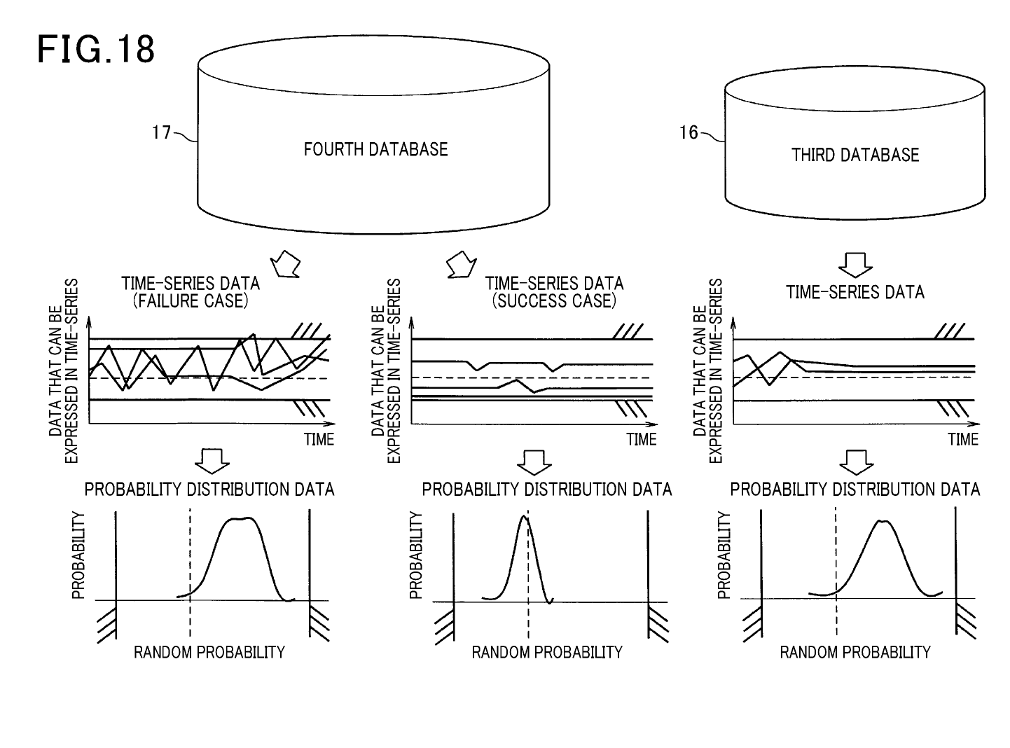

As in an example shown in FIG. 18, the evaluating unit 13 determines the average, dispersion, and bias of the current analysis result data acquired by the analyzing unit 12, that is, the evaluation target data stored in the third database 16, by a known statistical process. The evaluating unit 13 then generates a probability distribution of the evaluation target data based on the determined average, dispersion, and bias, by a known statistical process. In addition, the evaluating unit 13 determines whether or not the evaluation target data has recurrence (tendency to recur) (also referred to as regression or recursion), by a known statistical process. In the embodiments, recurrence indicates whether or not periodic or regular changes can be found in the target data. The evaluating unit 13 determines that the target data has recurrence when periodic or regular changes can be found in the target data.

In addition, the evaluating unit 13 determines the average, dispersion, and bias of the past data stored in the fourth database 17, by a known statistical process. The evaluating unit 13 then generates a probability distribution of the past data based on the determined average, dispersion, and bias. In addition, the evaluating unit 13 confirms whether or not the past data has recurrence. At this time, the evaluating unit 13 determines the average, dispersion, and bias for both the success-case data and the failure-case data stored in the fourth database 17, and generates the probability distributions of the success-case data and the failure-case data.

Then, the evaluating unit 13 verifies the degree of similarity between the probability distribution data of the evaluation target data and the probability distribution data of the success-case data, and the degree of similarity between the probability distribution data of the evaluation target data and the probability distribution data of the failure-case data. Then, when the probability distribution data of the evaluation target data and the probability distribution data of the success-case data match, or the probability distribution data of the evaluation target data is closer to the probability distribution data of the success-case data than the probability distribution data of the failure-case data, the evaluating unit 13 evaluates the business operation related to the current evaluation target data as being a business operation that has a high likelihood of success.

In addition, when the probability distribution data of the evaluation target data and the probability distribution data of the failure-case data match, or the probability distribution data of the evaluation target data is closer to the probability distribution data of the failure-case data than the probability distribution data of the success-case data, the evaluating unit 13 evaluates the business operation related to the current evaluation target data as being a business operation that has a high likelihood of failure.

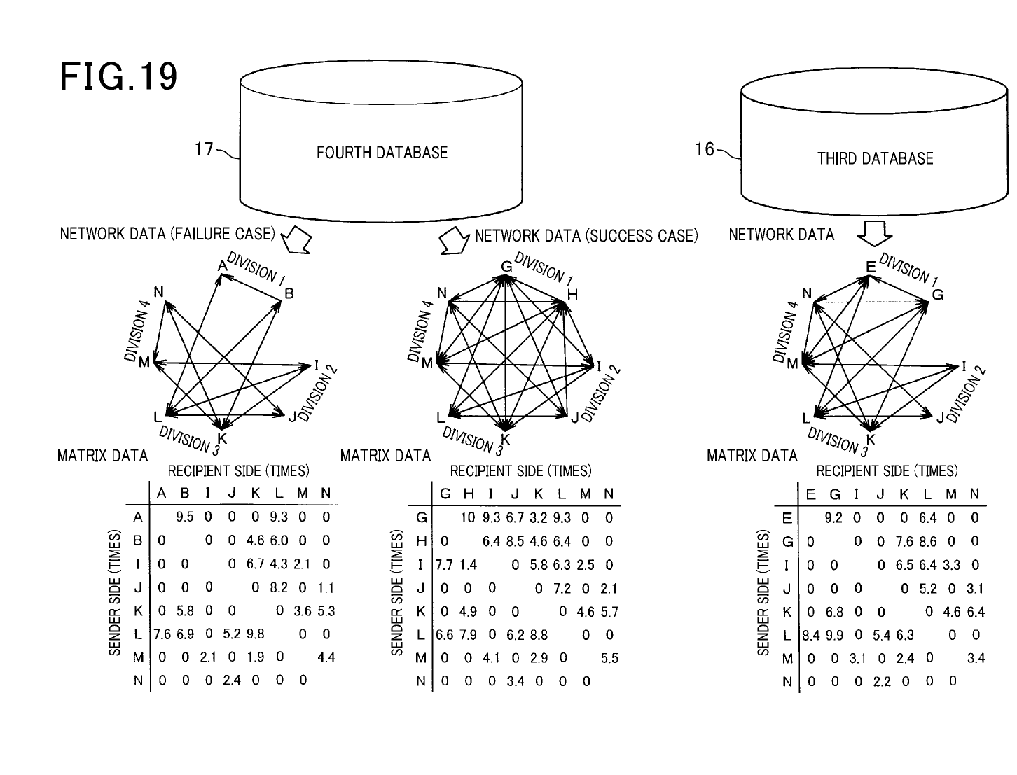

Furthermore, as shown in an example in FIG. 19, the evaluating unit 13 also evaluates the business operation related to the current evaluation target data based on the network data as well. The evaluating unit 13 performs the evaluation by comparing the evaluation target data stored in the third database 16 with the past data stored in the fourth database 17. That is, the evaluating unit 13 verifies the degree of similarity between a clustered aspect indicated by the network data in the evaluation target data and a clustered aspect indicated by the network data in the success-case data, and the degree of similarity between the clustered aspect indicated by the network data in the evaluation target data and a clustered aspect indicated by the network data in the failure-case data.

The clustered aspect indicates a data group formed within the network data, or in other words, a clustered distribution aspect. For example, in the network data in the failure-case data, a data group indicating transmission and reception of email among division 1, division 2, and division 4, that is, a formation of a cluster cannot be found. However, in the network data in the success-case data, a data group indicating transmission and reception of email among division 1, division 2, and division 4, that is, a formation of a cluster can be found.

Then, when the clustered aspect indicated by the network data in the evaluation target data and the clustered aspect indicated by the network data in the success-case data match, or the clustered aspect indicated by the network data in the evaluation target data is closer to the clustered aspect indicated by the network data in the success-case data than the clustered aspect indicated by the network data in the failure-case data, the evaluating unit 13 evaluates the business operation related to the current evaluation target data as being a business operation that has a high likelihood of success.

In addition, when the clustered aspect indicated by the network data in the evaluation target data and the clustered aspect indicated by the network data in the failure-case data match, or the clustered aspect indicated by the network data in the evaluation target data is closer to the clustered aspect indicated by the network data in the failure-case data than the clustered aspect indicated by the network data in the success-case data, the evaluating unit 13 evaluates the business operation related to the current evaluation target data as being a business operation that has a high likelihood of failure.

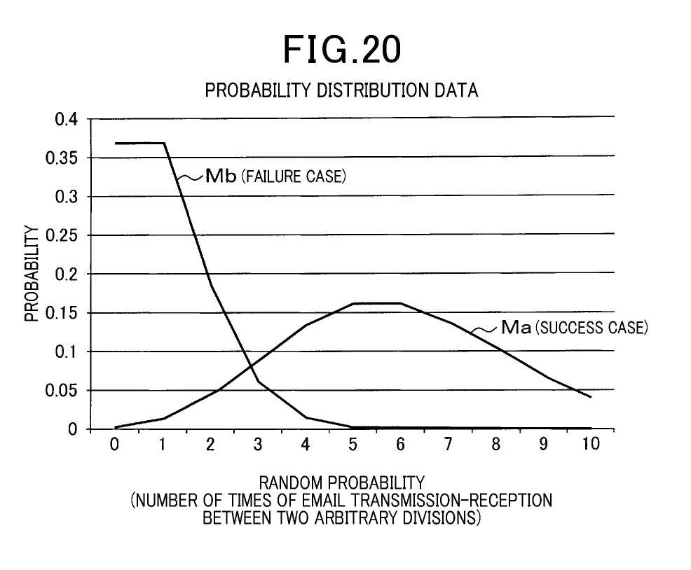

In addition, as shown in an example in FIG. 20, the evaluating unit 13 generates probability distribution data related to the number of times of the email transmission-reception between two arbitrary divisions, set as random probability, based on a known statistical process. In this case, based on probability distribution data Ma of the success-case data, the probability of a success case occurring is found to be higher when the transmission and reception of email between two arbitrary divisions is about five to six times. Meanwhile, based on probability distribution data Mb of the failure-case data, the probability of a failure case occurring is found to be higher when the transmission and reception of email between two arbitrary divisions is about zero to one time.

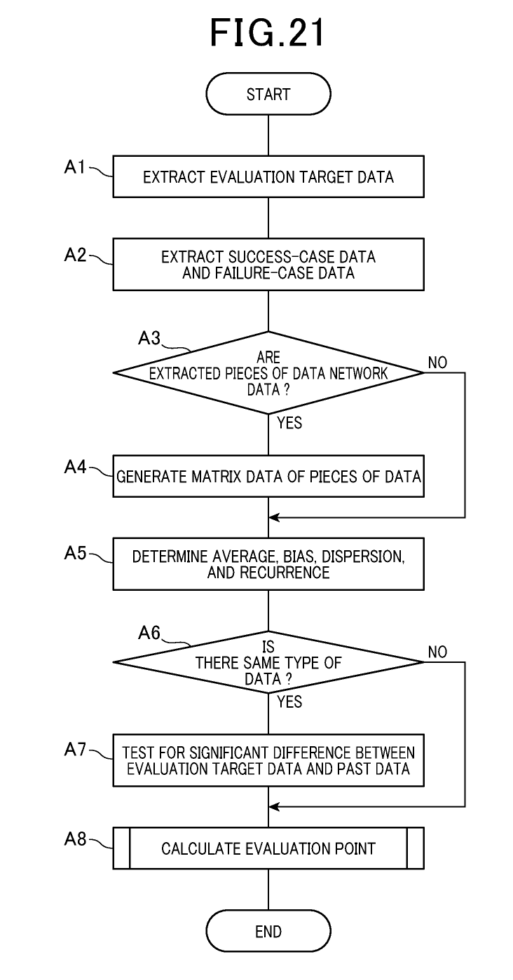

Next, an example of the business operation evaluation process performed by the business operation evaluation system 10 will be described. As shown in an example in FIG. 21, the business operation evaluation system 10 extracts the evaluation target data that is to be the current evaluation target from the third database 16 (step A1). In addition, the business operation evaluation system 10 extracts the success-case data and the failure-case data from the fourth database 17 as the past data (step A2).

Then, when the extracted pieces of data are network data (YES at step A3), the business operation evaluation system 10 generates matrix data of each piece of data (step A4) and proceeds to step A5. When determined that the extracted pieces of data are not network data (NO at step A3), the business operation evaluation system 10 proceeds to step A5 without generating matrix data of each piece of data.

Upon proceeding to step A5, the business operation evaluation system 10 determines the average, bias, dispersion, and recurrence for each extracted piece of data. When a plurality of pieces of evaluation target data, success-case data, and failure-case data are present, the business operation evaluation system 10 performs the processes at steps A1 to A5 on all pieces of data.

After performing the processes at steps A1 to A5 for all pieces of data, the business operation evaluation system 10 confirms whether or not data that can be considered to be the same type as the current evaluation target data and can be compared with the current evaluation target data is present within the past data extracted from the fourth database 17 (step A6). That is, the business operation evaluation system 10 confirms whether or not the past data of a business operation content similar to that of the current evaluation target data is present. At this time, the business operation evaluation system 10 disregards whether the past data is a success-case data or a failure-case data.

When determined that past data that is the same type as the current evaluation target data is present (YES at step A6), the business operation evaluation system 10 compares the average, bias, dispersion, and recurrence related to the past data with the average, bias, dispersion, and recurrence related to the current evaluation target data, and tests the degree of similarity between the two pieces of data (step A7).

Then, the business operation evaluation system 10 stores the test result. When determined that past data that is the same type as the current evaluation target data is not present (NO at step A6), the business operation evaluation system 10 does not perform the process at step A7. When a plurality of pieces of evaluation target data, success-case data, and failure-case data are present, the business operation evaluation system 10 performs the processes at steps A6 and A7 on all pieces of data.

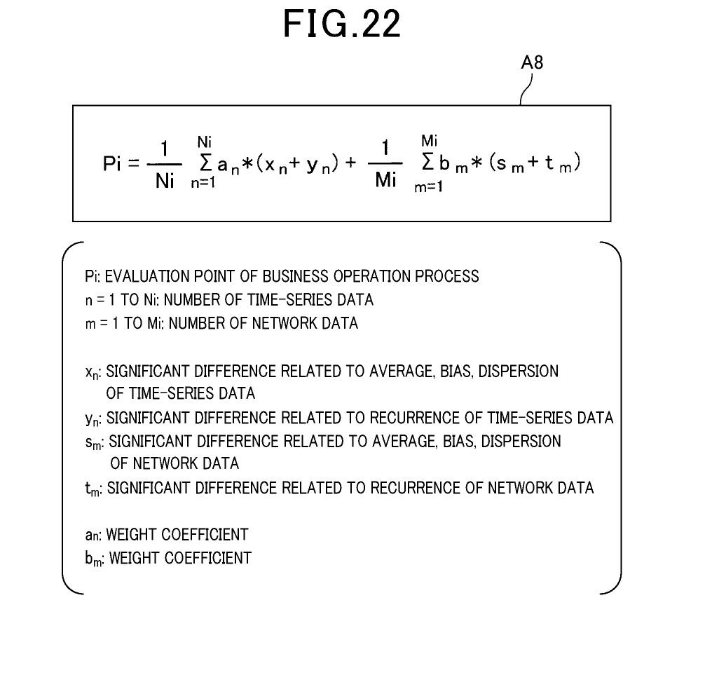

Then, after performing the processes at steps A6 and A7 on all pieces of data, the business operation evaluation system 10 proceeds to an evaluation point calculation process (step A8) for the business operation process. The evaluation point calculation process is performed based on an arithmetic expression shown in an example in FIG. 22.

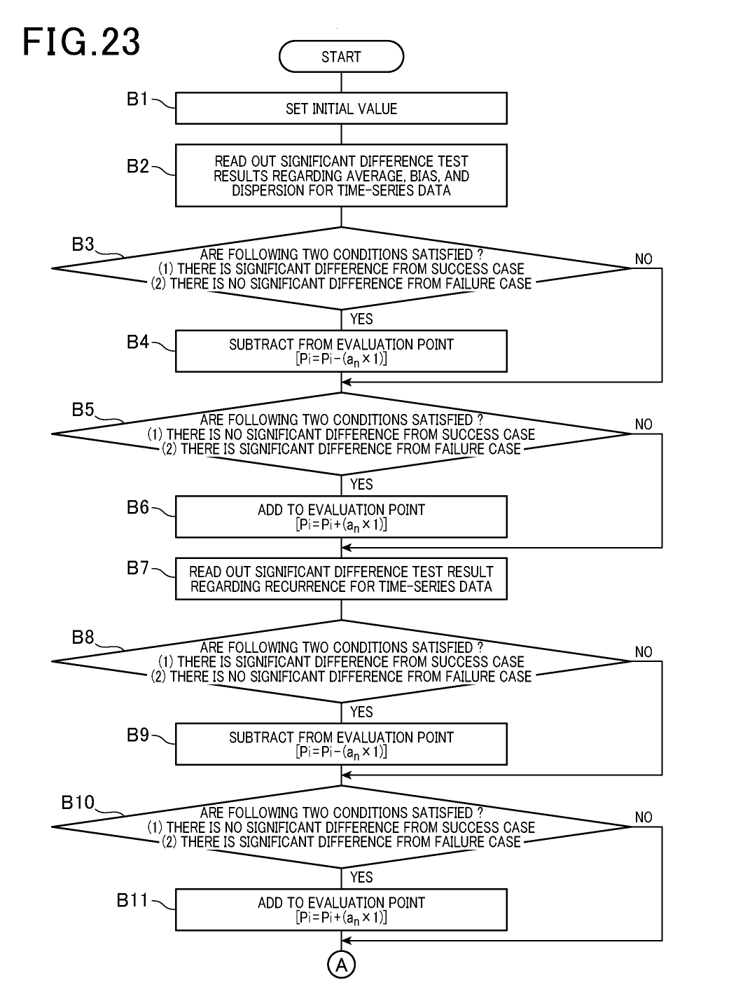

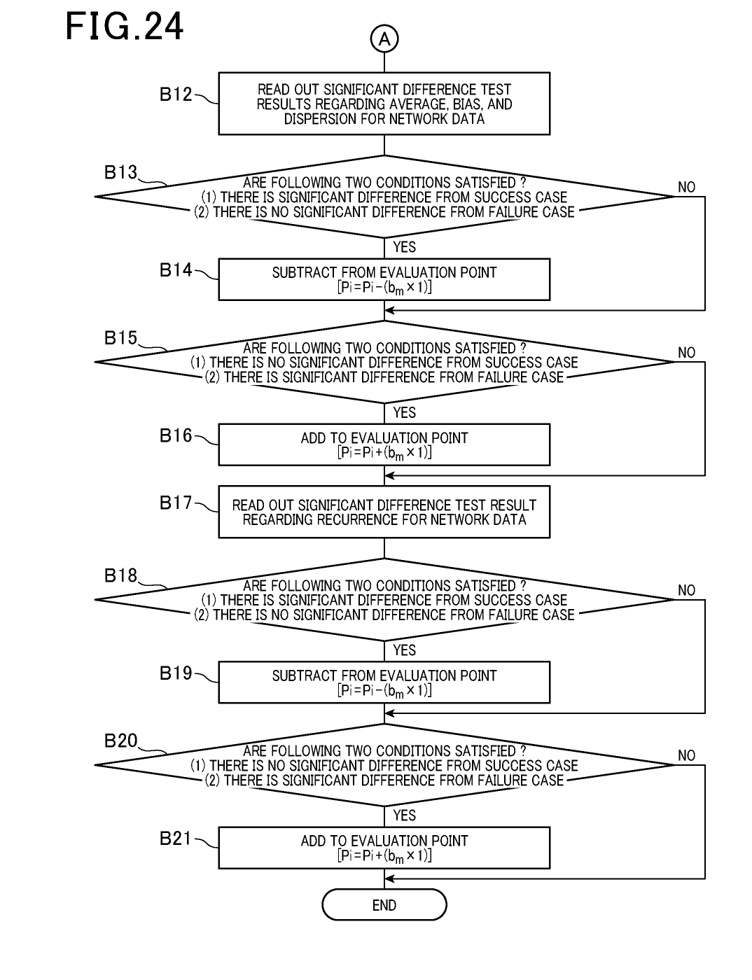

As shown in an example in FIG. 23 and FIG. 24, when the evaluation point calculation process is started, the business operation evaluation system 10 first sets an initial value of the evaluation point (step B1). In this case, the business operation evaluation system 10 sets 20 as the initial value.

Next, the business operation evaluation system 10 performs addition and subtraction of the evaluation point based on the results of comparison between the time-series data in the evaluation target data and the time-series data in the past data, or in other words, the results of a significant difference test. That is, the business operation evaluation system 10 reads out the test results regarding significant difference between the average, bias, and dispersion related to the time-series data in the evaluation target data, and the average, bias, and dispersion related to the time-series data in the past data (step B2).

Then, the business operation evaluation system 10 determines whether or not the following two conditions are satisfied: (1) there is a significant difference between the average, bias, and dispersion related to the time-series data in the evaluation target data and the average, bias, and dispersion related to the time-series data in the success-case data; and (2) there is no significant difference between the average, bias, and dispersion related to the time-series data in the evaluation target data and the average, bias, and dispersion related to the time-series data in the failure-case data (step B3).

When determined that: (1) there is a significant difference between the average, bias, and dispersion related to the time-series data in the evaluation target data and the average, bias, and dispersion related to the time-series data in the success-case data; and (2) there is no significant difference between the average, bias, and dispersion related to the time-series data in the evaluation target data and the average, bias, and dispersion related to the time-series data in the failure-case data (YES at step B3), the business operation evaluation system 10 subtracts a predetermined value from the evaluation point (step B4). In this case, the business operation evaluation system 10 subtracts weight coefficient aₙ×1 as the predetermined value. When determined NO at step B3, the business operation evaluation system 10 does not perform the subtraction process on the evaluation point.

Next, the business operation evaluation system 10 determines whether or not the following two conditions are satisfied: (1) there is no significant difference between the average, bias, and dispersion related to the time-series data in the evaluation target data and the average, bias, and dispersion related to the time-series data in the success-case data; and (2) there is a significant difference between the average, bias, and dispersion related to the time-series data in the evaluation target data and the average, bias, and dispersion related to the time-series data in the failure-case data (step B5).

When determined that: (1) there is no significant difference between the average, bias, and dispersion related to the time-series data in the evaluation target data and the average, bias, and dispersion related to the time-series data in the success-case data; and (2) there is a significant difference between the average, bias, and dispersion related to the time-series data in the evaluation target data and the average, bias, and dispersion related to the time-series data in the failure-case data (YES at step B5), the business operation evaluation system 10 adds a predetermined value to the evaluation point (step B6). In this case, the business operation evaluation system 10 adds weight coefficient aₙ×1 as the predetermined value. When determined NO at step B5, the business operation evaluation system 10 does not perform the addition process on the evaluation point.

Next, the business operation evaluation system 10 reads out the test result regarding significant difference between the recurrence related to the time-series data in the evaluation target data and the recurrence related to the time-series data in the past data (step B7). Then, the business operation evaluation system 10 determines whether or not the following two conditions are satisfied: (1) there is a significant difference between the recurrence related to the time-series data in the evaluation target data and the recurrence related to the time-series data in the success-case data; and (2) there is no significant difference between the recurrence related to the time-series data in the evaluation target data and the recurrence related to the time-series data in the failure-case data (step B8).

When determined that: (1) there is a significant difference between the recurrence related to the time-series data in the evaluation target data and the recurrence related to the time-series data in the success-case data; and (2) there is no significant difference between the recurrence related to the time-series data in the evaluation target data and the recurrence related to the time-series data in the failure-case data (YES at step B8), the business operation evaluation system 10 subtracts a predetermined value from the evaluation point (step B9). In this case as well, the business operation evaluation system 10 subtracts weight coefficient aₙ×1 as the predetermined value. When determined NO at step B8, the business operation evaluation system 10 does not perform the subtraction process on the evaluation point.

Next, the business operation evaluation system 10 determines whether or not the following two conditions are satisfied: (1) there is no significant difference between the recurrence related to the time-series data in the evaluation target data and the recurrence related to the time-series data in the success-case data; and (2) there is a significant difference between the recurrence related to the time-series data in the evaluation target data and the recurrence related to the time-series data in the failure-case data (step B10).

When determined that: (1) there is no significant difference between the recurrence related to the time-series data in the evaluation target data and the recurrence related to the time-series data in the success-case data; and (2) there is a significant difference between the recurrence related to the time-series data in the evaluation target data and the recurrence related to the time-series data in the failure-case data (YES at step B10), the business operation evaluation system 10 adds a predetermined value to the evaluation point (step B11). In this case as well, the business operation evaluation system 10 adds weight coefficient aₙ×1 as the predetermined value. When determined NO at step B10, the business operation evaluation system 10 does not perform the addition process on the evaluation point.

As described above, the business operation evaluation system 10 performs addition and subtraction of the evaluation point based on the significant difference test results regarding the time-series data in the evaluation target data and the time-series data in the past data. When a plurality of pieces of evaluation target data, success-case data, and failure-case data are present, the business operation evaluation system 10 performs the test for significant difference on all pieces of data and performs addition and subtraction of the evaluation point. Then, the business operation evaluation system 10 performs addition and subtraction of the evaluation point based on the results of comparison between the network data in the evaluation target data and the network data in the past data, or in other words, the results of a significant difference test.

That is, the evaluation system 10 reads out the test results regarding significant difference between the average, bias, and dispersion related to the network data in the evaluation target data, and the average, bias, and dispersion related to the network data in the past data (step B12). Then, the business operation evaluation system 10 determines whether or not the following two conditions are satisfied: (1) there is a significant difference between the average, bias, and dispersion related to the network data in the evaluation target data and the average, bias, and dispersion related to the network data in the success-case data; and (2) there is no significant difference between the average, bias, and dispersion related to the network data in the evaluation target data and the average, bias, and dispersion related to the network data in the failure-case data (step B13).

When determined that: (1) there is a significant difference between the average, bias, and dispersion related to the network data in the evaluation target data and the average, bias, and dispersion related to the network data in the success-case data; and (2) there is no significant difference between the average, bias, and dispersion related to the network data in the evaluation target data and the average, bias, and dispersion related to the network data in the failure-case data (YES at step B13), the business operation evaluation system 10 subtracts a predetermined value from the evaluation point (step B14). In this case, the business operation evaluation system 10 subtracts weight coefficient bₘ×1 as the predetermined value. When determined NO at step B13, the business operation evaluation system 10 does not perform the subtraction process on the evaluation point.

Next, the business operation evaluation system 10 determines whether or not the following two conditions are satisfied: (1) there is no significant difference between the average, bias, and dispersion related to the network data in the evaluation target data and the average, bias, and dispersion related to the network data in the success-case data; and (2) there is a significant difference between the average, bias, and dispersion related to the network data in the evaluation target data and the average, bias, and dispersion related to the network data in the failure-case data (step B15).

When determined that: (1) there is no significant difference between the average, bias, and dispersion related to the network data in the evaluation target data and the average, bias, and dispersion related to the network data in the success-case data; and (2) there is a significant difference between the average, bias, and dispersion related to the network data in the evaluation target data and the average, bias, and dispersion related to the network data in the failure-case data (YES at step B15), the business operation evaluation system 10 adds a predetermined value to the evaluation point (step B16). In this case, the business operation evaluation system 10 adds weight coefficient bm×1 as the predetermined value. When determined NO at step B15, the business operation evaluation system 10 does not perform the addition process on the evaluation point.

Next, the business operation evaluation system 10 reads out the test result regarding significant difference between the recurrence related to the network data in the evaluation target data and the recurrence related to the network data in the past data (step B17). Then, the business operation evaluation system 10 determines whether or not the following two conditions are satisfied: (1) there is a significant difference between the recurrence related to the network data in the evaluation target data and the recurrence related to the network data in the success-case data; and (2) there is no significant difference between the recurrence related to the network data in the evaluation target data and the recurrence related to the network data in the failure-case data (step B18).

When determined that: (1) there is a significant difference between the recurrence related to the network data in the evaluation target data and the recurrence related to the network data in the success-case data; and (2) there is no significant difference between the recurrence related to the network data in the evaluation target data and the recurrence related to the network data in the failure-case data (YES at step B18), the business operation evaluation system 10 subtracts a predetermined value from the evaluation point (step B19). In this case as well, the business operation evaluation system 10 subtracts weight coefficient bₘ×1 as the predetermined value. When determined NO at step B18, the business operation evaluation system 10 does not perform the subtraction process on the evaluation point.

Next, the business operation evaluation system 10 determines whether or not the following two conditions are satisfied: (1) there is no significant difference between the recurrence related to the network data in the evaluation target data and the recurrence related to the network data in the success-case data; and (2) there is a significant difference between the recurrence related to the network data in the evaluation target data and the recurrence related to the network data in the failure-case data (step B20).

When determined that: (1) there is no significant difference between the recurrence related to the network data in the evaluation target data and the recurrence related to the network data in the success-case data; and (2) there is a significant difference between the recurrence related to the network data in the evaluation target data and the recurrence related to the network data in the failure-case data (YES at step B20), the business operation evaluation system 10 adds a predetermined value to the evaluation point (step B21). In this case as well, the business operation evaluation system 10 adds weight coefficient bₘ×1 as the predetermined value. When determined NO at step B20, the business operation evaluation system 10 does not perform the addition process on the evaluation point.

As described above, the business operation evaluation system 10 performs addition and subtraction of the evaluation point based on the significant difference test results regarding the network data in the evaluation target data and the network data in the past data. When a plurality of pieces of evaluation target data, success-case data, and failure-case data are present, the business operation evaluation system 10 performs the test for significant difference on all pieces of data and performs addition and subtraction of the evaluation point.

As described above, the business operation evaluation system 10 compares the data on the business operation to be the current evaluation target and the data on a business operation that has been evaluated in the past. The business operation evaluation system 10 then adds and subtracts the evaluation point based on the comparison results, and evaluates the current business operation.

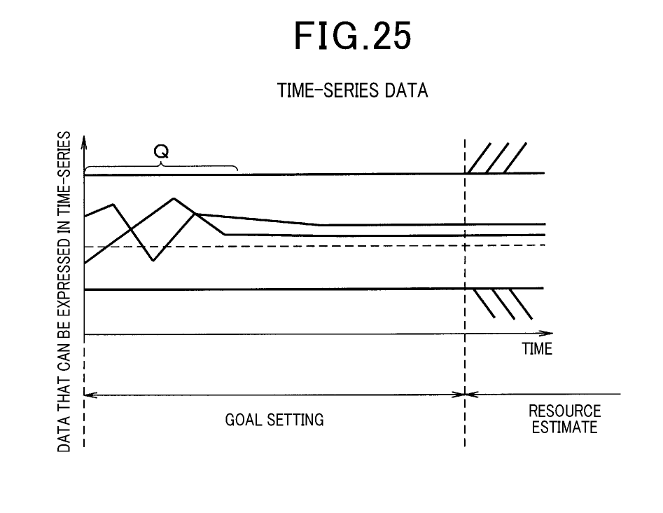

In addition, the evaluating unit 13 can divide the period during which the business operation related to the evaluation target data has been performed into a plurality of periods. The evaluating unit 13 can then identify a period that has a high necessity for business operation improvement, among the plurality of divided periods, as an improvement-required period (quality-decrease concern period). That is, as shown in an example in FIG. 25, the evaluating unit 13 can identify a period that is thought to have a particularly high necessity for business operation improvement, in the time-series data, as the improvement-required period Q.

In this case, the evaluating unit 13 divides the period during which the business operation related to the evaluation target data has been performed into a plurality of periods. For each period, the evaluating unit 13 adds to and subtracts from the evaluation point in the manner described above, with the initial value set to 20. Then, the evaluating unit 13 identifies a period of which the evaluation point, which has been calculated for each period, is lower than a predetermined concern value as the improvement-required period Q. The predetermined concern value can be set such as to be changed as appropriate. However, in this case, 10, for example, is set.

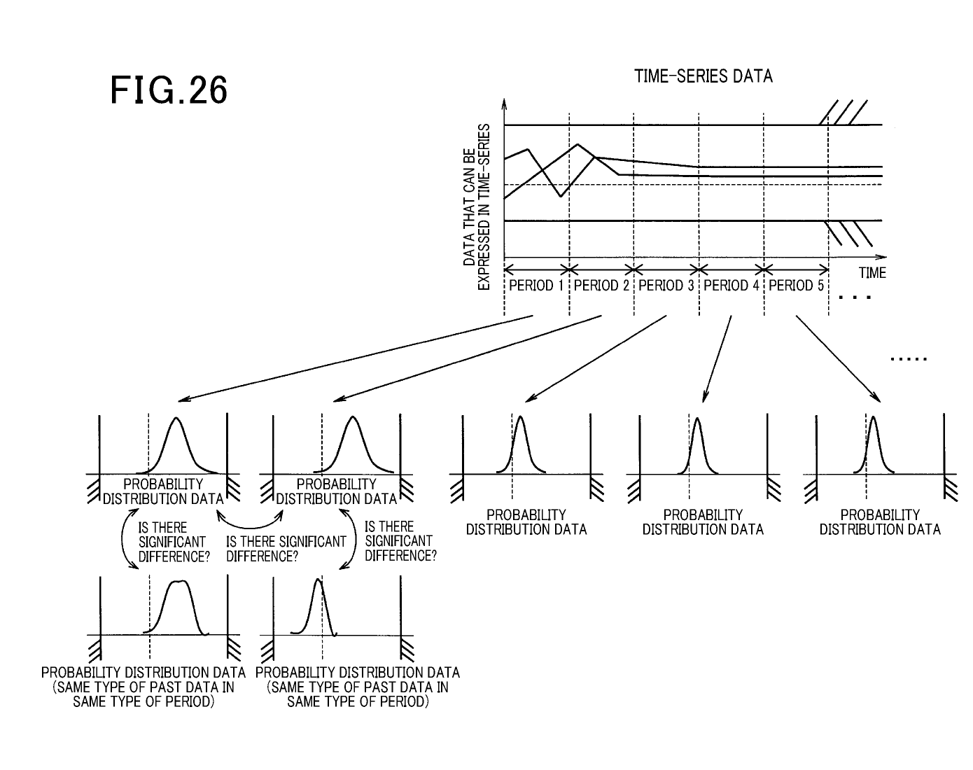

In addition, as shown in an example in FIG. 26, the evaluating unit 13 determines the average, dispersion, and bias for each divided period, and generates probability distributions. Then, the evaluating unit 13 compares the pieces of probability distribution data that precede and follow each other, and confirms whether or not there is a significant difference. In addition, the evaluating unit 13 compares the probability distribution data of each period with the probability distribution data of the same type of period in the same type of past data, and confirms whether or not there is a significant difference. The evaluating unit 13 can then also set a period in which it is confirmed that there is a significant difference between pieces of probability distribution data that precede and follow each other and it is also confirmed that there is a significant difference between the probability distribution data and the probability distribution data of the same type of period in the same type of past data as the improvement-required period.

In the business operation evaluation system 10, the business operation data is collected from the in-house system 100, and the current evaluation target data is automatically generated from the collected data. Then, the current evaluation target data that has been generated is evaluated based on a comparison with the past data that has been evaluated in a past business operation evaluation process. Therefore, unlike the conventional method in which each relevant staff answers a questionnaire created by an administrator, the subjective views of the administrator and the relevant staffs are not easily reflected in the data to be evaluated.

In addition, the burden of creating the questionnaire is not placed on the administrator, and the burden of answering the questionnaire is not placed on the relevant staffs. Furthermore, the burden of aggregating the answered questionnaires is not placed on the administrator or an analyst. Therefore, the business operation content can be objectively evaluated without requiring time and effort by the administrator and relevant staffs, and while eliminating the subjective views of people.

In addition, in the business operation evaluation system 10, the current business operation content is evaluated based on the degree of similarity between the current evaluation target data and the past success-case data, and the degree of similarity between the current evaluation target data and the past failure-case data. That is, the evaluation is performed based on whether the current business operation content is similar to a past success case or a past failure case. Therefore, a highly accurate evaluation based on past cases can be performed.

In addition, in the business operation evaluation system 10, the fourth database 17 classifies the past data into the success-case data and the failure-case data, and stores the data therein. The evaluating unit 13 then evaluates the current evaluation target data based on the degree of similarity between the current evaluation target data and the success-case data, and the degree of similarity between the current evaluation target data and the failure-case data. Therefore, the current business operation content can be evaluated with high accuracy based on comparisons with past success cases and failure cases.

In addition, in the business operation evaluation system 10, even when the data ascertained from the in-house system 100 includes the time-series data, which is expressed in time-series, and the network data, which is expressed by a network between elements configuring a business operation, analysis and evaluation of both types of data can be accommodated.

In addition, in the business operation evaluation system 10, the evaluating unit 13 divides the period during which the business operation related to the current evaluation target data has been performed into a plurality of periods. The evaluating unit 13 then identifies a period that has a high necessity for business operation improvement, among the plurality of divided periods, as the improvement-required period. That is, the business operation period in the current business operation that particularly requires improvement can be accurately identified, and a more detailed business operation evaluation can be performed.

In addition, in the business operation evaluation system 10, the business operation data collecting unit 11 collects the business operation data present within a company. Then, the analyzing unit 12 analyzes the business operation data collected by the business operation data collecting unit 11. The evaluating unit 13 performs evaluation of the business operation data collected by the business operation data collecting unit 11. That is, in the business operation evaluation system 10, no special business operation data is required. Analysis and evaluation of a business operation can be performed based on the business operation data present solely in the in-house system 100.

The present disclosure is not limited to the above-described embodiment. Various modifications are possible without departing from the spirit of the invention. For example, the probability distribution used for data analysis is not limited to a normal distribution. For example, the Poisson distribution that expresses the number of occurrences of a random event per unit period, the chi-square distribution for testing bias and dispersion in data, the empirical cumulative distribution for testing whether or not the probability distributions of two populations differ, or the exponential distribution that expresses the interval between the occurrences of a random event may be used.

What is claimed is:

1. A business operation evaluation system comprising:
a business operation data collecting unit that collects business operation data related to a business operation;
a first database that stores therein analysis data used to analyze the business operation data collected by the business operation data collecting unit;
a second database that associates therein names of business operation phases indicating stages of the business operation and names of processes included in the business operation phases, and stores the names therein;
an analyzing unit that analyzes the business operation data collected by the business operation data collecting unit using the analysis data stored in the first database;
a third database that stores therein, as evaluation target data, analysis result data acquired through the analysis performed by the analyzing unit;
a fourth database that stores therein, as past data, the analysis result data stored in the third database as the evaluation target data; and
an evaluating unit that evaluates the evaluation target data stored in the third database by comparing the evaluation target data with the past data stored in the fourth database.

2. The business operation evaluation system according to claim 1, wherein:
the past data stored in the fourth database are classified into success-case data and failure-case data; and
the evaluating unit evaluates the evaluation target data based on a degree of similarity between the evaluation target data and the success-case data, and the degree of similarity between the evaluation target data and the failure-case data.

3. The business operation evaluation system according to claim 2, wherein:
the analysis result data includes time-series data expressed in time-series, and network data expressed by a network between elements configuring the business operation.

4. The business operation evaluation system according to claim 3, wherein:
the evaluating unit divides a period during which the business operation related to the evaluation target data is performed into a plurality of periods, and identifies a period having a high necessity for business operation improvement, among the plurality of periods, as an improvement-required period.

5. The business operation evaluation system according to claim 4, wherein:
the business operation data collecting unit collects the business operation data present within a company.

6. The business operation evaluation system according to claim 1, wherein:
the analysis result data includes time-series data expressed in time-series, and network data expressed by a network between elements configuring the business operation.

7. The business operation evaluation system according to claim 1, wherein:
the evaluating unit divides a period during which the business operation related to the evaluation target data is performed into a plurality of periods, and identifies a period having a high necessity for business operation improvement, among the plurality of periods, as an improvement-required period.

8. The business operation evaluation system according to claim 2, wherein:
the evaluating unit divides a period during which the business operation related to the evaluation target data is performed into a plurality of periods, and identifies a period having a high necessity for business operation improvement, among the plurality of periods, as an improvement-required period.

9. The business operation evaluation system according to claim 1, wherein:
the business operation data collecting unit collects the business operation data present within a company.

10. The business operation evaluation system according to claim 2, wherein:
the business operation data collecting unit collects the business operation data present within a company.

11. The business operation evaluation system according to claim 3, wherein:
the business operation data collecting unit collects the business operation data present within a company.

12. A business operation evaluation method comprising:
collecting, by a business operation data collecting unit, business operation data related to a business operation;
storing, in a first database, analysis data used to analyze the business operation data collected by the business operation data collecting unit;
storing, in a second database, names of business operation phases indicating stages of the business operation and names of processes included in the business operation phases, the names of business operation phases and the names of processes are associated with each other;
analyzing, by an analyzing unit, the business operation data collected by the business operation data collecting unit using the analysis data stored in the first database;
storing, in a third database, as evaluation target data, analysis result data acquired through the analysis performed by the analyzing unit;
storing, in a fourth database, as past data, the analysis result data stored in the third database as the evaluation target data; and
evaluating, by an evaluating unit, the evaluation target data stored in the third database by comparing the evaluation target data with the past data stored in the fourth database.
